(19) United States
(12) Patent Application Publication
(10) Pub. No.: US 2013/0132124 A1
(43) Pub. Date: May 23, 2013

(54) SYSTEM FOR DELIVERING AND AGGREGATING BENEFICIARY VOTING TICKET HAVING FUNCTION FOR CONVERSION TO DEMERIT VOTE

(71) Applicant: Hiroshi Kusunoki, Kunigami-gun (JP)

(72) Inventor: Hiroshi Kusunoki, Kunigami-gun (JP)

(73) Assignees: Shoji KEMMOCHI, Chiyoda-ku (JP); Nobuko TANADA, Kunigami-gun (JP); Hidetsugu OUCHI, Yokohama-shi (JP)

(21) Appl. No.: 13/520,392

(22) PCT Filed: Dec. 9, 2010
(86) PCT No.: PCT/JP2010/072099

§ 371 Date: Jul. 3, 2012

(30) Foreign Application Priority Data
Jan. 4, 2010 (JP) 2010-011409
Feb. 1, 2010 (JP) 2010-034048
Apr. 8, 2010 (JP) 2010-100325
Oct. 12, 2010 (JP) 2010-241435

(51) Int. Cl. G06Q 40/08

(52) U.S. Cl. CPC G06Q 40/08
USPC 705/4

(57) ABSTRACT

Disclosed is a delivery and aggregation system for a charity beneficiary ballot which has a function for converting a vote to a demerit vote. The system is for polls for selecting charity beneficiaries which are carried out in conjunction with insurance policy for damage insurance or third field insurance, which includes medical insurance, cancer insurance and pet insurance. Votes which are/have been sent by an insured person who has caused an insurance accident, and are/have been sent in a specific period corresponding to each insurance accident covered by an individual policy, are converted to demerit votes, which is determined for each occurrence of an insurance accident.

### TECHNICAL FIELD

The present invention relates to a computer system supporting a vote for a beneficiary in case of the third field insurance, such as a medical, cancer or damage insurance (including a mutual contract and a pet insurance similar to these types of insurance). More specifically, the present invention relates to a system for a vote for a beneficiary mainly realized by a server connected to the internet and by a program.

### BACKGROUND ART

There is a conventional server or program for a motor insurance management (for example, a patent literature 1). The server is connected to a customer's terminal device via internet and performs a vote. In the vote, the server does not aggregate a vote if it is voted by an insurance contractor who caused an accident during an insurance period, or the server does not give voting ticket to such an insurance contractor. An internet motor insurance managing server or program with a function of questionnaire of the prior patent literature 1 is invented by the inventor of the present application. Its patent application was filed by applicants including an inventor of the present application and the patent application has been allowed.

### PRIOR ART DOCUMENTS

### Patent Literatures

Patent Literature 1: JP 4214158 B

### SUMMARY OF THE INVENTION

### Problems to be Solved by the Invention

In the field of insurance, a life insurance is called the first field. A damage insurance is called the second field. An insurance that does not belong to the first and second field is called the third field. The insurances in the third field include a medical insurance, a cancer insurance, a care (expense) insurance, an income insurance. A medical special agreement is treated and explained the same as the insurances in the third field in this description.

The damage insurance compensates a damage caused by an accident. Examples of the damage insurance include a fire, motor, marine, transport, pet, travel, golf and accident insurance.

An insurance company undertakes the payment of the insurance money if an accident occurs in the predetermined conditions written in the insurance contract. Such an accident is called an insurance accident. An insurance company must pay the insurance money based on an event other than an accident, if the occurred event obligates the insurance company to pay. An insurance accident is a wide-ranging concept including such an event. The event must be caused by chance. However, when the event will be caused does not need to be known beforehand.

The examples of an insurance accident include a hospitalization or an operation for a medical insurance, a burning-down of a building by a fire for a fire insurance and an occurrence of liability for damages for a liability insurance. In the case of an insurance of the third field and a damage insurance, insurance accidents occur many times and at the same time (for example, an operation and a hospitalization) during the insurance period. Therefore, the insurance money is paid every time the insurance accidents occur. For example, two or more insurance accidents, such as an operation and a hospitalization, can occur during 10 years of the insurance period of a medical insurance. In this case, the insurance money can be paid every time the insurance accidents occur, as long as the number of the insurance accidents is within the predetermined number (for example, total hospitalization days are within 500 days).

The contract of the insurance of the third field and the damage insurance corresponding to such an insurance accident can be concluded through an insurance agent other than an insurance company that undertakes directly the insurance contract. Thereinafter, “an insurance agent” may be called shortly “agent.”

The insurance agent mediates between the insurance contractor and the insurance company based on a request from the insurance company. The examples of the mediation include, sale of insurance, collection of insurance fee, negotiation with accident counterpart, attendance at accident, receipt of accident certification, confirmation of insurance money payment condition, representative service for the whole insurance contract, temporary advance of insurance fee, contract performance, brokering, mailing of diverse notifications, communication by e-mail and customer management.

The insurance agent includes an agent that limits his operation to introducing an insurance contractor or a potential insurance contractor to an insurance company via internet. This type of agent is called a mediation agent.

In many cases of donation, there is a broker between the donator and the beneficiary, though the donator donates the money directly to the beneficiary in several cases. Now a broking server technique is advocated that can perform a large part of whole processes for donation.

The case that there is a broker for donation causes a problem that it is necessary to confirm whether the beneficiary is selected in accordance with the donator's will. The prior patent literature 1 discloses a voting system that allows a donator to select directly the beneficiary via internet.

The prior patent literature 1 discloses that if an insurance contractor of a motor insurance does not cause an accident (it is called no-accident contractor), the no-accident contractor can donate by using the voting system without paying an additional insurance fee corresponding to the money for donation. The voting system of the prior patent literature 1 gives a demerit to an insurance contractor that causes an insurance accident by invaliding his vote voted during the predetermined period and by preventing from giving him a voting ticket during the predetermined period.

However, it is a common rule for all insurance contracts that all insurance contractors must be treated fairly for financial conditions such as the insurance fee or the bonus. The insurance company has a rule that it pays back bonus fairly to the all insurance contractors, if surplus fund more than expected occurs in an insurance contract wherein the insurance fee is fairly determined Specifically, the amount of bonus paid to no-accident contractors is equal to the amount of bonus paid to the insurance contractors that caused an accident (it is called an accident contractor).

This raises a problem that giving a right to donate (financial merit) only to the no-accident contractor contradicts the above mentioned fair financial rule. In order to solve this problem, a system has been requested that, on the one hand, gives the financial merit to donate to all insurance contractors without condition, and on the other hand, deprives the accident contractor of the right to select the beneficiary based on his will and assigns a predetermined beneficiary forcibly to the accident contractor. The accident contractor looses the non-financial merit to select freely the beneficiary. However, the accident contractor can keep the financial merit itself to donate to some beneficiary even if the beneficiary is against his will.

The system and program of the prior patent literature 1 do not aggregate voting data voted by the accident contractors that caused variety of insurance accidents (such as a hospital visit, a hospitalization, an operation), or do not give a voting ticket to the insurance contractor that caused an insurance accident during the predetermined period. The system and program can not perform detailed processing in accordance with each kind of insurance accident for each insurance of the third field or damage insurance.

However, in the case of an insurance of the third field or damage insurance, there are many kinds of insurance accidents. The examples of the insurance accidents include a hospital visit, a hospitalization, an operation, a category of disease or injury and a category of operation, for example, in the case of a medical insurance. Therefore, a system has been requested that can respond for each insurance accident for each insurance contract.

The system and program of the prior patent literature 1 can not set various periods (days) during which the system and program cancel the vote corresponding to certain kinds of insurance accidents, or prevent from giving a voting ticket corresponding to certain kinds of insurance accidents, for each insurance contract of the insurance of the third field or the damage insurance. The period may be defined using a time length such as 30 days and 1 year, or may be defined using the starting date and the ending date such as from Jan. 1, 2010 to Mar. 15, 2011. A system has been requested that can predetermine the various periods during which the system cancels the vote corresponding to certain kinds of insurance accidents, or prevent from giving a voting ticket corresponding to certain kinds of insurance accidents, for each insurance accident and for each insurance contract of the insurance of the third field or the damage insurance.

The system and program of the prior patent literature 1 can not set and update (convert) different beneficiaries for each insurance accident for each insurance contract of the insurance of the third field and the damage insurance. A system has been requested that can set candidate beneficiaries for each insurance contract, in keeping precisely the correspondence relations, for example, an organization supporting orphans of car accidents for a motor insurance, or an organization supporting abandoned pet for a pet insurance, so that the candidate beneficiaries are associated with the corresponding insurance contract and insurance accident.

The above mentioned problems can be solved by a system performing both setting the various periods and converting forcibly a vote voted during the periods to a vote for the predetermined limited candidate beneficiaries.

In the case of an insurance of the third field and a damage insurance, insurance accidents occur many times and at the same time during the insurance period. For example, in case of a lifetime medical insurance, the first insurance money was paid 5 years ago for 10 days' hospital visits and the second insurance money was paid this year for 50 days' hospitalization. In this case, it is necessary to convert a vote voted during these periods (10 days or 50 days) to a vote for the predetermined limited candidate beneficiaries and to return, after these periods, to the normal state wherein all candidate beneficiaries can be selected.

However, the invention of the prior patent literature 1 cancels uniformly all votes during the insurance periods. The invention can not select the votes voted during the predetermined period which is a part of the insurance period and can not return to the normal state after canceling only the selected votes. Therefore, a system has been requested that cancels only votes voted during the predetermined sub-period associated with each insurance accident within the insurance period, without uniformly canceling all votes voted during the insurance period, and returns to normal state after the predetermined sub-period.

In case of an insurance of the third field and a damage insurance, insurance accidents are likely to occur many times and at the same time during the insurance period. For example, the first insurance accident (a hospitalization) occurs, and within the period of the hospitalization, the second insurance accident (an operation) occurs. However, once an insurance accident occurs during the insurance period, the invention of the prior patent literature 1 can not respond to each of two or more insurance accidents and cancels uniformly all votes voted during the insurance period. Both of the first case that an insurance accident occurs and the second case that two insurance accidents occur cause the same result that all votes voted during the same insurance period are uniformly canceled. Therefore, a system has been requested that can respond to the case that two or more insurance accidents occur at the same time.

### Means to Solve the Problems

In order to solve the problem, the present invention is a system for delivering and aggregating a vote with function to convert a voting ticket to a demerit voting ticket, the system displays home page of an insurance organization, a guide that an insurance organization and insurance contractor make a donation and that the insurance organization includes an agent that sales an insurance of a third field including a medical insurance and a cancer insurance, and a damage insurance including a pet insurance, and a list information comprising a candidate beneficiary for which the insurance contractor or an insured person can vote,

converts the voting ticket to the demerit voting ticket with a predetermined demerit function during a specific period within an insurance period,
comprises; a storage means storing a insurance contractor database, a conversion period database, an aggregated votes data and an accident-beneficiary database, wherein the conversion period database associating a conversion period during which the voting ticket is converted to the demerit voting ticket with a category of the insurance accident or a category of a payment of insurance money for each of the insurance contract,
a vote delivery and aggregation means sending the voting ticket via network to a terminal device operated by the insurance contractor or the insured person for each of the specific period and aggregating the voting ticket sent back from the insurance contractor or the insured person to store a result of the aggregation in the storage means,
an insurance accident information receiving means receiving, from a computer system for managing insurance contracts, an insurance accident information indicating the category of the insurance accident or the category of the payment of insurance money for each of the insurance contract,
a demerit information processing means, responsive to receiving the insurance accident information by an insurance accident information receiving means, retrieving the conversion period database using as a key the category of the insurance accident or the category of the payment of insurance money for each of the insurance contract to obtain the conversion period corresponding to the received insurance accident information and
storing the obtained conversion period or the category of the insurance accident or a period for the payment of insurance money for each of the insurance contract in an individual insurance contractor information corresponding to the received insurance accident information,
a vote conversion means converting the sent back voting ticket from the insurance contractor or the insured person corresponding to the received insurance accident information to the demerit voting ticket during the conversion period or the period for the payment of insurance money and aggregating or re-aggregating a number of the converted voting ticket or the conversion period or the period for the payment of insurance money stored in the individual insurance contractor information.

These components can convert a voting ticket already voted or aggregated to a demerit voting ticket whose demerit is to impose a demerit on the accident contractor and re-aggregate the voting ticket already voted or aggregated in case that it is known that the voting date is within the predetermined conversion period after having received and aggregated the voting ticket from the insurance contractor or the insured person.

The vote delivery and aggregation means of the present invention further receives the voting ticket via network including internet from the terminal device operated by the insurance contractor or the insured person,

writes a voting date of the received voting ticket and the beneficiary selected by the voting ticket in the received individual insurance contractor information stored in the storage means
converts the beneficiary selected by the voting ticket to a predetermined beneficiary, in case that the voting date is within the conversion period already written in the individual insurance contractor information and
aggregates the converted beneficiary.

These components can convert a newly received voting ticket to the demerit ticket and re-aggregate the converted demerit ticket, by storing the conversion period for each insurance accident associated with an information of the insurance contractor or the insured person that has caused the insurance accident, in case that it is known that the time of having newly received the voting ticket is within the conversion period.

The vote delivery and aggregation means of the present invention, when sending newly the voting ticket, further

retrieves the conversion period from the individual insurance contractor information to identify the insurance contractor whose conversion period includes a date of sending the voting ticket and
converts the voting ticket to the demerit voting ticket to send the converted demerit voting ticket to the identified insurance contractor or determining not to send the voting ticket to the identified insurance contractor.

These components can convert a voting ticket to be newly sent to the demerit ticket and sent the converted demerit voting ticket or determine not to send the voting ticket, by storing the conversion period for each insurance accident associated with an information of the insurance contractor or the insured person that has caused the insurance accident, in case that it is known that the time of newly sending the voting ticket is within the already written conversion period.

The demerit information processing means of the present invention, after receiving the insurance accident information by insurance accident information receiving means, further

obtains the beneficiary for each of the insurance accident corresponding to the insurance accident information from the accident-beneficiary database using as a key the category of the insurance accident or the category of the payment of insurance money for each of the insurance contract and
stores the obtained beneficiary for each of the insurance accident in an individual insurance contractor information corresponding to the received insurance accident information or
the vote conversion means of the present invention,
converts the beneficiary for the insurance contractor or the insured person corresponding to the received insurance accident information to the beneficiary for each of the insurance accident, and aggregates or re-aggregates the beneficiaries.

These components can set the beneficiary selected by the demerit voting ticket for each insurance contract and for each insurance accident. For example, the system is applied to a motor insurance and a medical insurance, it is necessary to distinguish the beneficiary in accordance with the characteristics of the each insurance, because a beneficiary to be ideally supported by the insurance brings a sense of affinity to the insurance contractor. In case of the motor insurance, it is preferable to support orphans of car accidents. In case of the medical insurance, it is preferable and brings more sense of affinity to support those who have serious diseases.

It is possible to set different beneficiaries for the demerit voting ticket, in accordance with the age or the residence area of the voting person of the same motor insurance. In more detail, it is possible to set different beneficiaries for each of the voting person. In this way, it is possible to set a preferable beneficiary in accordance with the category of insurance, the characteristic of the voting person, the time and the age or the area of voting.

The demerit information processing means of the present invention further determines whether the date when the obtained conversion period is to be newly written in the individual insurance contractor information is included within the old conversion period already written in the individual insurance contractor information, in case that the date is included within the already written conversion period,

calculates and writing a new ending date of the conversion period by adding the obtained conversion period to the old conversion period with a new starting date being the following date of the ending date of the old conversion period or
updates the old conversion period by summing up the old conversion period and the obtained conversion period,
in case that the date is not included within the already written conversion period, determines not to change the sent back voting ticket.

These components can sum up a plurality of predetermined conversion periods without overlapping and come back to the normal state after the conversion period every time the insurance accident occurs repeatedly during the insurance period of the insurance of the third field such as a medical insurance or a cancer insurance or a damage insurance.

During the insurance period of the insurance of the third field such as a medical insurance or a cancer insurance or a damage insurance, a plurality of insurance accidents can occur at the same time (for example, a hospitalization and an operation of the medical insurance). In this way, even if two or more insurance accidents or payments of insurance money occur at the same time for a specific insurance contract, it is possible to write a new conversion period based on the two or more insurance accidents etc.

The insurance contractor information of the present invention is one or more of a mail address, a zip code, an address, name, sex, an age, telephone number, an identification number or code of the insurance contractor determined by the insurance contractor or the agent and serial number of the insurance policy, or the insurance accident information of the present invention is one or more of an information related to the insurance contractor or the insured person, a name of the insurance company, a name of the insurance contractor, a name of the insurance accident, a date of occurrence of the insurance accident, a date of payment of insurance money or a benefit, a period of payment of insurance money or the benefit.

These components can set detailed conversion periods (for example, 18 days for a hospitalization) in accordance with an insurance contractor, an insured person, an insurance company, a category of insurance, an insurance contract, two or more categories of insurance accidents etc.

The process of the present invention to convert to the demerit voting ticket fixes the beneficiary to a pre-displayed candidate beneficiary or converts the beneficiary already selected by the voting ticket forcibly to the pre-displayed candidate beneficiary.

These components can convert a voting ticket of an accident contractor to a demerit voting ticket without a non-financial right to freely select a beneficiary, so that the beneficiary must be fixed to the pre-displayed beneficiary. It is also possible to set the beneficiary, so that voting tickets can be distributed equally to all the pre-displayed candidate beneficiaries.

The insurance accident information receiving means of the present invention further receives the insurance accident information from the terminal device operated by the insurance contractor or the insured person via a network.

These components allow an accident contractor to self-report an insurance accident and can set a converted period based on the self-report.

These components also allow the system to receive information related to occurrence of an insurance accident during a conversion period from a terminal device operated by an insurance contractor or an insured person via network. In other words, the insurance contractor, the insured person or their family can self-report the insurance accident to the insurance organization by using the terminal device operated by the insurance contractor or the insured person to send one or more of electric mail address, zip code, address, name, sex, age, telephone number, serial number of insurance policy and detail of the insurance accident on behalf of the insurance contractor.

The system has effects as followings. For example, in a typical case of cancer insurance, the family of the insured person does not want to inform the insured person of the fact that the insured person is suffering a cancer.

It is natural in this case for the family to notify the insurance company of the fact to request the benefit. However, the family does not wish that the insured person or the agent knows the fact or the family often wishes to keep the fact a secret from anyone other than the insurance company that pays the insurance money.

This means that the insurance company must treat information about the insurance accident very carefully by understanding well sentiments of the insurance contractor, the insured person or their family. In this case that the agent provides the voting, the insurance company does not inform the agent of occurrence of the insurance accident after having received a request for benefit from the family. In other words, from the standpoint of the insurance company, the family's sentiment to keep the fact a secret from the insurance contractor or the insured person suffering from a cancer is much more important than the business step to provide the agent with the fact.

It is for responding to the voting performed by the agent that the family having known the insurance accident (occurrence of cancer) can self-report. The family need not self-report to the agent, if the family does not wish to inform the insurance accident of the agent.

In case that the insurance company or the agent recognizes the necessity to self-report occurrence of such an insurance accident, the computer system of the insurance company or the agent does not receive information of occurrence of the insurance accident, but, the side of voting (the insurance contractor, the insured person or their family) can self-report.

### Effect of the Invention

The present invention can, firstly, inhibit an insurance contractor from selecting freely a beneficiary both before and after the voting, secondly, fix the selected beneficiary to a predetermined demerit beneficiary, or, thirdly, re-aggregate the voted ticket, during a predetermined conversion period for each insurance accident and for each insurance contract of an insurance of the third field or a damage insurance in case of voting for beneficiary of these insurances.

This allows the system to give to the accident contractor a financial merit of the right itself to vote and to deprive the accident contractor of a non-financial merit of the right to select freely a beneficiary. On the other hand, this allows the system to give the non-accident contractor both the financial merit and the non-financial merit.

Therefore, the accident contractor can be treated equally to the non-accident contractor from the financial standpoint. The principle can be kept that all insurance contractors are financially equal, even if the demerit is imposed. Voting itself can not be realized if whether the insurance contract with voting can be concluded depends on how to impose the demerit. Therefore, this principle is an essential condition for imposing the demerit on the accident contractor.

The system can set detailed demerits (length of the conversion period and a beneficiary) that are not uniform but are corresponding to each insurance accident (a hospital visit, a hospitalization, an operation, a category of disease or injure etc. in case of a medical insurance).

The remaining part of the insurance period after conversion period can be returned to the normal state wherein the demerit is not imposed. It is possible to combine two or more conversion periods corresponding respectively to two or more insurance accidents, in case that a new insurance accident occurs or two or more insurance accidents occur at the same time during the passed part of insurance period wherein the demerit is imposed.

Additionally, even after the accident contractor votes, a stored and aggregated beneficiary that has been selected by the accident contractor can be converted to a predetermined demerit beneficiary to be re-aggregated. This allows the system to convert a vote voted before the insurance accident to a demerit vote corresponding to an unpredictable insurance accident.

This means that even a vote after voting may be converted to a demerit vote if the insurance contractor causes an insurance accident. The insurance contractor makes an effort to prevent conversion of the vote to the demerit vote. This effort is nothing but an effort to prevent the insurance accident. The present invention is, in other words, a program that appeals to motivation of the insurance contractor for reducing the number of insurance accidents.

The system can perform the program that appeals to motivation of the insurance contractor for reducing the number of the insurance accidents. The program is realized both for depriving the accident contractor of the non-financial right to select freely a beneficiary and for giving to the accident contractor the financial right itself to vote, even if the beneficiary is predetermined. The program is based on a principle that all insurance contractors are financially equal.

In case of a medical insurance, the fact that an insurance contractor has not caused an insurance accident (the insurance contractor has not received an insurance money or a benefit for reason of disease or injure) means that the insurance contractor is in a healthy and energetic state. If the insurance contractor donates something to a beneficiary selected by the insurance contractor, it means, as a result, that the insurance contractor donates his own health or energy to the beneficiary selected by him or the insurance contractor donates the money to the beneficiary selected by him. The insurance contractor can not donate the money to the beneficiary selected by him during the conversion period.

From a standpoint of the insurance contractor or the insured person, it is a strong motivation for keeping health and energy that the insurance contractor or the insured person can donate the money to the beneficiary selected by him. The insurance company can use the motivation as a tool for reducing the number of the insurance accidents and the payment of the insurance money or the benefit to maximize profit. In case of a pet insurance, a pet owner can donate the money (resulting from health of the pet) to the beneficiary selected by the pet owner.

### BRIEF DESCRIPTION OF THE DRAWINGS

FIG. 1 illustrates a block diagram of the system for delivering and aggregating beneficiary voting tickets having function for conversion to demerit vote.

FIG. 2 illustrates a flowchart of an embodiment of the system for delivering and aggregating beneficiary voting tickets having function for conversion to demerit vote.

FIG. 3 illustrates an example of individual conversion period table in a conversion period database. This example is for medical insurance B of damage insurance company A. The individual conversion period table is stored in the conversion period database for each category of insurance of each insurance company.

FIG. 4 illustrates an example of individual insurance contractor information.

FIG. 5 illustrates an example of individual accident-beneficiary table stored in an accident-beneficiary database (16). This example is for medical insurance B of damage insurance company A. The individual accident-beneficiary table is stored in the accident-beneficiary database for each category of insurance of each insurance company.

### EMBODIMENTS FOR CARRYING OUT THE INVENTION

### The First Embodiment

There is a set of insurance contracts of the third field, such as a medical insurance and a cancer insurance, or a damage insurance concluded with an insurance organization (or through the insurance agent) and a medical or cancer special agreement of a life insurance (including a mutual contract and a pet insurance similar to these types of insurance). This set includes a sub-set. The sub-set includes insurance contracts wherein the insurance organization allows the insurance contractor or the insured person to vote for one of candidate beneficiaries. The invention of the present application can be applied to this sub-set. However, thereinafter, a medical insurance will be explained representatively with reference of the drawings.

There is a common contractual point between the medical insurance used for the example and the group including other insurances of the third field or a damage insurances or a medical/cancer special agreement of a life insurance. The common contractual point is that an insurance period is determined and some kind of insurance accidents are defined. Therefore, voting for the beneficiary for the group is performed in the same way as the medical insurance used for the example.

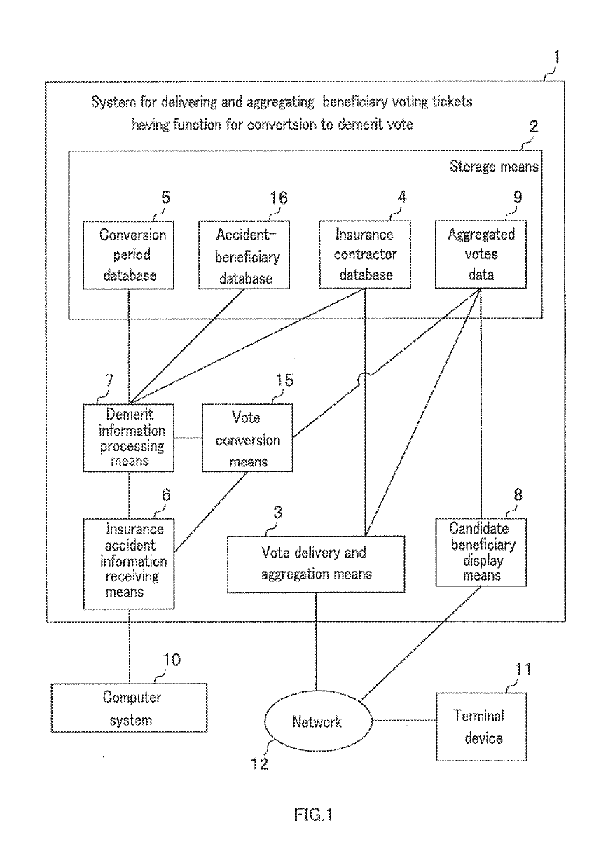

The FIG. 1 is a block diagram of the system 1 in accordance with the first embodiment of the present invention. The system 1 illustrated in the FIG. 1 is a computer system for supporting a vote for beneficiary in case of an insurance contract, comprising, at the center, a server capable to be connected with a network 12, such as internet, and a database controlled by the server.

The system 1 comprises a storage means 2, a vote delivery and aggregation means 3, an insurance accident information receiving means 6, a demerit information processing means 7, a candidate beneficiary display means 8 and a vote conversion means 15. One or more computer programs stored in the system 1 realize functions of these means.

The storage means 2 stores an insurance contractor database 4, a conversion period database 5, an aggregated votes data 9 and an accident-beneficiary database 16.

A customer capable to access the system 1 via a network 12 such as internet is mainly an insurance contractor or an insured person of a concluded insurance contract. The insurance contractor concludes an insurance contract of a medical insurance with an insurance company using a personal computer or a mobile device.

In principle, the insurance contractor or the insured person can access the system 1 connected with a network 12 such as internet by using a terminal device 11 to communicate with the system.

An insurance contract, concluded by an insurance contractor or whose insured person is the insurance contractor himself, predetermines an insurance period, such as 1 year, 5 years, 10 years or lifetime. The insurance contract predetermines also, for each insurance company, an insurance accident that is a reason why an insurance money is paid by the insurance company.

For example, there is medical insurance B of insurance company A. The insurance period of the medical insurance B is 10 years. The insurance accidents of the medical insurance B are a hospital visit, a hospitalization, an operation and death for each category of disease or injure. Insurance money paid for each insurance accident is generally called a hospital visit benefit, a hospitalization benefit, an operation benefit or a death benefit. The hospital visit benefit and the hospitalization benefit can be calculated by multiplying a benefit unit per day by the number of the hospital visit days or hospitalization days caused by the disease or injure. For, example, the benefit unit per day of the hospital visit benefit is 5,000 yens, the benefit unit per day of the hospitalization benefit is 10,000 yens.

The benefit is paid in accordance with an actual number of hospital visit days or hospitalization days for diseases predetermined in the insurance contract. The operation benefit is calculated based on the benefit unit per 1 operation.

For example, in case that an insurance contractor is hospitalized for 20 days and the hospitalization benefit unit is 10,000 yens, the hospitalization benefit to be paid is 200,000 yens (10,000 yens×20 days). An insurance contract of a general medical insurance predetermines an upper limit day number for each hospital visit or each hospitalization to limit the benefit amount, such as 60 hospital visit days for one disease or 120 hospitalization days for one disease. Additionally, in case that the insurance contractor repeats hospital visits or hospitalizations, the insurance contract often predetermines also an upper limit cumulated day number for total hospital visit or total hospitalization. For, example, the upper limit cumulated day number for total hospitalization is 1,200 days.

In a medical insurance, there is another rule than above mentioned limits. For example, the amount of a hospital visit benefit, a hospitalization benefit or an operation benefit can be predetermined differently in accordance with the category of the disease or the category of the operation.

A certain category of disease or injure interdicts payment of the hospital visit benefit, the hospitalization benefit or the operation benefit. Thus, for each medical insurance, there are many kinds of insurance accidents that are reasons why the insurance money or the benefit can not be paid.

On the other hand, a vote for beneficiary provided by an insurance organization with an insured person (that is an insurance contractor at the same time in many case) is as followings.

(i) The insurance organization keeps a fund. A source of the fund is the insurance fee received by the insurance organization from the insurance contractor. In case that there is an insurance agent, the fund is the received fee after deducing sale fee from it by the insurance agent.

(ii) It is from this fund that the donation is paid to a medical organization, a nature protection organization or a charity organization etc. on behalf of the insurance organization, the insured person or the insurance contractor.

(iii) The insurance organization presents all candidate beneficiaries, such as mentioned above, to the insurance contractor or the insured person. The insurance organization aggregates the votes for each beneficiary from the insurance contractors or the insured persons to determine one beneficiary.

(iv) The system 1 performs this aggregation of the vote using the network such as internet.

Voting for a beneficiary must be performed so that all insurance contractors and all insured persons of the same type of insurance contract are treated fairly. This allows a financial merit of donating to be given fairly to all insurance contractors and all insured persons. This matches the fundamental rule of fairness among the insurance contractors. Another merit is given to the insured persons that have not caused an insurance accident. The other merit is restricted to no-financial merit acceptable within the fundamental rule. The other merit is called a right to select a beneficiary.

The insured person makes efforts not to cause an insurance accident (a hospital visit, a hospitalization, etc.) in order to obtain a right to select freely a beneficiary. This right is a no-financial merit that allows the insured person to donate to a beneficiary that the insured person likes best. These efforts allow the insurance company to minimize payment of the benefit or the insurance money and to maximize profit.

In principle, an insurance company must treat fairly all insurance contractors (including insured persons) because the insurance company sells insurances to non-exclusive public. For a specific insurance contract, if the number of insurance accident reduces, the profit increases more than expected. The insurance company often pays a part of the profit (the bonus) back to the insurance contractors. However, in principle, all insurance contractors must be financially equal. The principle obliges the insurance company to pay the bonus back to the accident contractors, even if the accident contractors do not contribute to the profit of the insurance company.

It is preferable that a merit given to the no-accident contractors (that did not receive insurance money) is not a financial merit, such as receipt of the bonus or payment to a beneficiary, but a non-financial right to select freely a beneficiary. In other words, it is preferable that the accident contractors keep a right to donate as same as the no-accident contractors, but abandon a right to select freely a beneficiary.

The system 1 does not deprive the accident contractors of the right to vote for a beneficiary. Instead, it becomes necessary for the system to convert a beneficiary selected by an accident contractor to another beneficiary that the accident contractor does not select. This deprivation of the right to select freely a beneficiary corresponds to the non-financial demerit imposed on the accident contractor by the insurance company. However, the right to vote itself is not deprived. Therefore, the donation itself is performed.

As described above, one insurance contract corresponds to many insurance accidents. It is necessary that a non-financial demerit is determined in accordance with each insurance accident. The system 1 can meet the necessity.

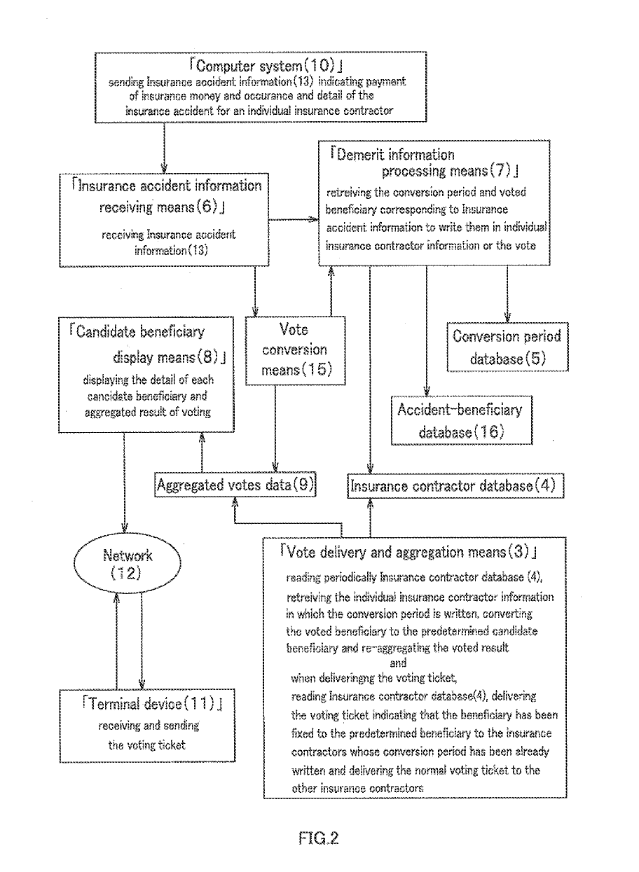

The FIG. 2 is a flowchart of the system 1. The processes performed by the system are explained along the FIG. 2.

Firstly, prior processes of the flowchart of the FIG. 2 are explained. The system 1 delivers a voting ticket for a beneficiary via an internet to a terminal device operated by an insurance contractor (or insured person) that concluded a specific insurance contract. The voting ticket is delivered periodically through the insurance period, such as once per month or once per three months. The insurance contractor selects a beneficiary from the candidate beneficiaries displayed on the candidate beneficiary display means (8) by the insurance organization. The terminal device of the insurance contractor transmits the selected beneficiary to the system (1) via internet. This transmission is called a vote for beneficiary. The system aggregates all votes for beneficiary including the vote mentioned above and other votes.

After voting, the system 1 imposes a non-financial demerit on an insurance contractor or an insured person that caused an accident as follows.

The insurance company or the agent of the insurance company has a computer system 10. The computer system 10 transmits to the system 1 insurance accident information 13 indicating payment of insurance money and occurrence and detail of the insurance accident for an individual insurance contractor or insured person.

The insured accident information receiving means 6 of the system 1 receives the insurance accident information 13 and sends the insurance accident information 13 to the demerit information processing means 7.

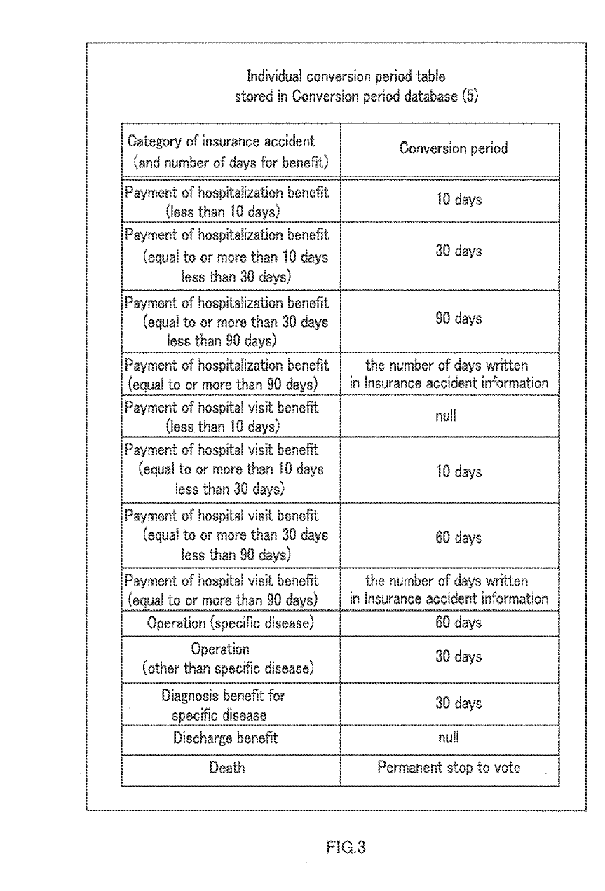

The received insurance accident information 13 includes a name of the insurance company, a category of the insurance contract and a category of the insurance accident. In an individual conversion period table (FIG. 3), the category of the insurance accident is associated with a conversion period. Therefore, the demerit information processing means 7 can retrieve a conversion period from the individual conversion period table in the conversion period database 5 stored in a storage means 2 using the category of the insurance accident etc. as key. The demerit information processing means 7 retrieves the individual insurance contractor information 14 corresponding to the received insurance accident information 13 and writes the retrieved conversion period on the individual insurance contractor information 14 stored in the insurance contractor database 4.

In case that the aggregated votes data 9 has one or more voted data corresponding to the received insurance accident information 13, the vote conversion means 15 converts the voted beneficiary to a specific beneficiary predetermined by the insurance organization for the conversion period. The specific beneficiary may be anyone that will be determined by the insurance organization, even if the “anyone” has not been already determined

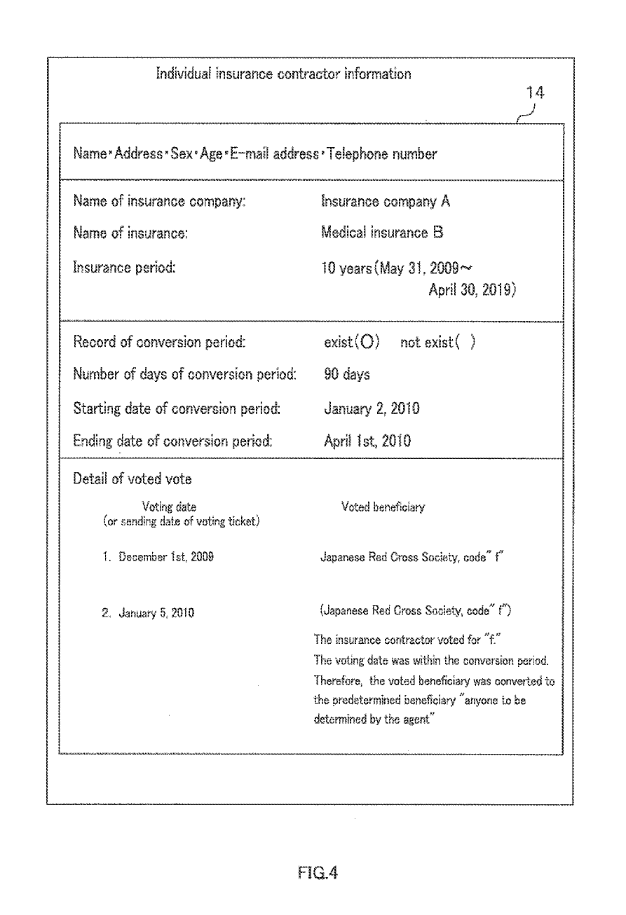

For example, the received insurance accident information 13 indicates that an insurance contractor has concluded a medical insurance contract B with the insurance company A, and the insurance contractor caused an insurance accident and the insurance company paid the insurance money (benefit) to the insurance contractor for 45 days' hospitalization. The conversion period database 5 stores the individual conversion period table (FIG. 3) for the medical insurance contract B of the insurance company A. The demerit information processing means 7 retrieves the individual conversion period table to obtain a conversion period of “90 days” corresponding to “Payment of hospitalization (equal to or more than 30 days less than 90 days.” The storage means 2 stores the insurance contractor database 4. The insurance contractor database 4 stores the individual insurance contractor information 14 (FIG. 4) for each insurance contractor. The demerit information processing means 7 writes the conversion period of “90 days” on the individual insurance contractor information 14 corresponding to the insurance contractor included in the received insurance accident information 13.

Specifically, the demerit information processing means 7 may write a starting date, a ending date and number of the days of the conversion period. For example, the starting date is a specific date such as Jan. 2, 2010. In this case, the number of days is the obtained “90 days” starting from Jan. 2, 2010.

The starting date of the conversion period may be one of the followings (i)-(iv).

(i) The date when the insurance accident information receiving means 6 received the insurance accident information 13.
(ii) The date when the insurance accident occurred.
(iii) The date when the insurance money or the benefit was paid.
(iv) A future date when the insurance money or the benefit will be paid (for example, Mar. 4, 2010), determined by the insurance organization

The number of days of the conversion period may be a period directly written in the received insurance accident information 13, instead of the conversion period stored in the individual conversion period table (FIG. 3) for each insurance company and for each category of insurance. In case that the insurance accident is included in predetermined categories, the number of days of the conversion period may be determined based on the individual conversion period table (FIG. 3). In other cases, the number of days of the conversion period may be a period directly written in the received insurance accident information 13.

For another example, the conversion period in the FIG. 3 may be “60 days” for the payment of benefit of the operation, or “the number of days written in the insurance accident information” for the payment of benefit of the hospital visit or the hospitalization. The demerit information processing means 7 can select one of these numbers of days and write it in the individual insurance contractor information 14. However, in case that the received insurance accident information 13 does not have any insurance accident stored in the individual conversion period table (FIG. 3), the conversion period is not selected nor set.

A symbol, such as “o” shown FIG. 4, may be marked in ( ) of “exist”, if the conversion period is written. On the following day of the ending date written in FIG. 4, the number of days, the starting date and ending date of the conversion period are deleted and the symbol “o” is moved to in ( ) of “not exist.”

In such a way, it is only during the conversion period that a beneficiary is forcibly converted. After the converted period, a normal state wherein the forcible conversion is impossible comes back. In this way, every time insurance accidents occur during the conversion period, the system 1 can impose a demerit on the accident contractor. The demerit is non-financial and corresponds to each category of the insurance accident (a hospital visit, a hospitalization or an operation).

The reason why both the number of days and the starting date of the conversion period are written is that a demerit needs to be imposed on the accident contractor only during a limited period within the whole insurance period.

In case that the insurance period is short such as 1 year, the demerit imposed on the accident contractor may invalid all voting tickets for 1 year. In case that the insurance contract has different insurance periods, different insurance accidents often occur many times during the insurance periods. Responsive to this situation, it is necessary to impose different demerits corresponding to each insurance accident every time the insurance accident occurs.

In case that the insurance contractor of the above mentioned medical insurance is hospitalized for 45 days, the insurance money (benefit) corresponding to the 45 days is requested to the insurance company, the insurance company pays the insurance money to the insurance contractor.

Then, the computer system 10 of the insurance company sends to the system 1 the information that the insurance money for 45 days was paid. Finally, the conversion period of 90 days is written in the individual insurance contractor information 14 of the insurance contractor that has received the insurance money for 45 days.

Then, the vote delivery and aggregation means 3 delivers a voting ticket via a network 12, such as internet, to the insurance contractor or the insured person written in the individual insurance contractor information 14. The voting ticket is delivered periodically during the insurance period, for example, once per month or once per three months.

However, the vote delivery and aggregation means 3 makes sure to confirm, at the time of the periodical delivery, that a conversion period is written in the individual insurance contractor information 14.

In case that a conversion period is written and that the time of delivery of the voting ticket is within the conversion period, the voting ticket to be delivered has a message that a specific beneficiary predetermined by the insurance company will be assigned or the insurance company is allowed to determine freely a beneficiary, even if the insurance contractor selects another beneficiary.

In a normal case, the insurance contractor or the insured person sends (votes) back to the insurance company the voting ticket in which a beneficiary is written. The vote delivery and aggregation means 3 converts the written beneficiary to the specific beneficiary predetermined by the insurance company or a beneficiary newly and freely determined by the insurance company, and aggregates the voting ticket.

There is a case that it is recognized after the aggregation that the time of delivery or return of the voting ticket is within the conversion period. In this case, the vote conversion means 15 considers that the written (voted) beneficiary has been automatically converted to the specific beneficiary predetermined by the insurance company or a beneficiary newly and freely determined by the insurance company, and aggregates the converted voting ticket again. The candidate beneficiary display means 8 may display the re-aggregated result.

In another way, the insurance accident information receiving means 6 performs the conversion and the re-aggregation mentioned above, every time the insurance accident information receiving means 6 receives the insurance accident information 13 for an individual insurance contractor. The candidate beneficiary display means 8 may display the re-aggregated result. Re-aggregated voting tickets may be distributed equally to the displayed candidate beneficiaries.

This way can convert the demerit votes equally to the displayed candidate beneficiaries. It is preferable that the forcible candidate beneficiaries are displayed clearly and previously.

As described above, a demerit (conversion of beneficiary) is imposed on an accident contractor only during the conversion period selected in accordance with received insurance accident.

On the contrary, a no-accident contractor of a medical insurance can donate his own health or energy having realized “no-accident” to a beneficiary selected by himself.

### The Second Embodiment

The demerit information processing means 7 retrieves a conversion period (A) from the conversion period database 5 and writes the retrieved conversion period in the individual insurance contractor information 14. There is a case that the date of the conversion period (A) to be written is overlapped with the date of the conversion period (B) already written in the individual insurance contractor information 14.

In this case, the demerit information processing means 7 determines a starting date of the newly retrieved conversion period (A) so that the starting date falls on the following date of the ending date of the already written conversion period (B). In other words, the demerit information processing means 7 updates the conversion period by adding the newly retrieved conversion period (A) to the already written conversion period (B). The other processes are the same as the first embodiment.

### The Third Embodiment

There is a case that the demerit information processing means 7 retrieves two or more conversion periods at the same time from the conversion period database 5.

In such a case that two ore more conversion periods are to be written simultaneously or sequentially in the individual insurance contractor information 14, the ending date is updated by summing up the two or more newly retrieved conversion periods. If the date is overlapped, the processes of the second embodiment are performed.

For example, there is a case that the insurance accident information 13 indicates as followings: “The insured person of medical insurance B of damage insurance company A receives a diagnosis. The insured person is suffering from a specific disease predetermined by the insurance contract. The insured person was hospitalized for 103 days and received a benefit for 103 days.”

In this case, the demerit information processing means 7 retrieves two conversion periods from the in individual conversion period table (FIG. 3) stored in the conversion period database 5. The first is “30 days” corresponding to “diagnosis benefit for specific disease.” The second is “the number of days written in insurance accident information” corresponding to “Payment of hospitalization benefit (equal to or more than 90 days).” In this case, “the number of days written in insurance accident information” is 103 days. The demerit information processing means 7 sums up the 30 days and the 103 days to make a combined conversion period of total 133 days. Even if three or more conversion periods are retrieved, they are treated in the same way.

The demerit information processing means 7 writes the combined conversion period and the starting date (the date when the insurance accident information 13 is received, or, the date written in the insurance accident information 13) in the individual insurance contractor information 14. If the date of the combined conversion period to be written is overlapped with the date of the already written conversion period, the process of the second embodiment is performed. The other processes are the same as the first embodiment.

### The Fourth Embodiment

The system 1 is applicable to an insurance of the third field, such as a medical insurance and a cancer insurance, a damage insurance or a medial or cancer agreement of a life insurance (including a mutual contract and a pet insurance similar to these types of insurance) that have an insurance period less than 1 year. These insurances include an overseas travel insurance, a golf insurance, a motor insurance, a fire insurance and an accident insurance.

In case of such a short period insurance less than 1 year, there are two ways to associate the conversion period with the insurance accident in the individual conversion period table (FIG. 3). Firstly, one conversion period may be associated with all insurance periods. Secondly, the different conversion periods may be associated with each insurance accident.

The examples of the first way include a case that a whole insurance period became automatically a conversion period if the whole insurance period is less than 1 year. The other processes are the same as the first embodiment.

The difference between the two ways is explained below using an example of a motor insurance having an insurance period less than 1 year.

The second way associates the different conversion periods with each insurance accident. In this case, the information stored in the individual conversion period table (FIG. 3) is as follows: “The whole insurance period becomes the conversion period if the insurance accident is a bodily accident.” “The conversion period is 100 days in any case, if the insurance accident is a property damage accident.” Specifically, “the whole insurance period” is associated with “a bodily accident” and “100 day” is associated with “a property damage accident.”

No conversion period is determined if information other than a bodily accident and a property damage accident is received. After the 100 days of the case of the property damage accident, a normal state comes back.

The examples of the first way include a case that a whole insurance period became automatically a conversion period if the insurance period is less than 1 year. Whatever insurance accident (including a bodily accident and a property damage accident) occurs, the whole insurance period becomes the conversion period if the whole insurance period is less than 1 year. In other words, all beneficiaries that have been already voted and all beneficiaries that will be voted during the whole insurance period are uniformly converted to a specific predetermined beneficiary.

As described above, the system 1 can set variety types of conversion period in accordance with an intention of an insurance organization realizing a vote for beneficiary.

In both the first and second ways, it is possible to convert a freely voted beneficiary to a beneficiary predetermined by the insurance organization without depriving the accident contractor of the right to vote. Because the right itself for the insurance contractor to donate can be kept, it is possible to observe the principle that all insurance contractors are financially equal so that all insurance contractors can receive fairly a financial benefit such as a bonus and service goods, even if the accident contractor is deprived of the non financial right to freely select the beneficiary.

### The Fifth Embodiment

The insurance contractor can send directly to the system 1 the insurance accident information 13 indicating payment of insurance money or occurrence and detail of an insurance accident.

The fifth embodiment allows an insurance contractor (including an contractor of a mutual contract) or an insured person to self-report that the insurance contractor or the insured person has caused an insurance accident. The fifth embodiment also allows the system 1 to set a conversion period based on the self-report.

In this case, the insurance contractor sends directly to the system 1 via a network such as internet an insurance accident information 13 indicating payment of insurance money or occurrence and detail of an insurance accident. The system 1 receives the insurance accident information 13. The processes after receiving the insurance accident information 13 are the same as the embodiments 1-4 wherein the computer system 10 of an insurance company transmits to the system 1 the insurance accident information 13.

In case that the insurance contractor sends directly to the system 1 an insurance accident information 13 indicating payment of insurance money or occurrence and detail of an insurance accident, it is preferable that a voting ticket has a communication field to write the occurrence of the insurance accident. This allows the insurance contractor to self-report at the time of voting for a beneficiary.

The system 1 or the insurance organization may send to the insurance contractor or the insured person a question message such as “Have you caused an insurance accident?” and receive the response message. In this case, the system 1 may recognize that an insurance accident has not occurred if the system 1 receives no response message.

Such a self-report allows a candidate insurance contractor before an official contract conclusion to take part in a vote and allows the system 1 to set a conversion period.

The insurance organization can not know that the candidate insurance contractor has caused an insurance accident before an official contract conclusion. However, the system 1 can set a conversion period if the system 1 receives a self-report directly from the candidate insurance contractor. This allows the candidate insurance contractor to take part in a vote for a beneficiary, even if the vote is only a simulation or a trying.

The taking part by a candidate insurance contractor in the simulation or the trying provides the insurance organization with an important tool for obtaining new insurance contractors. Additionally, the simulation or the trying allows the system 1 to convert a freely selected beneficiary to a specific beneficiary predetermined by the insurance organization or a beneficiary selected by “a simulation or a trying.” This means that the candidate insurance contractor can select a beneficiary by the simulation or the trying.

The insurance contractors having already concluded an insurance contract can determine a beneficiary by voting. However, distribution of fund among the beneficiaries can be determined by candidate insurance contractors. Specifically, it is possible to calculate amount of donation for each beneficiary based on the proportion of the number of votes for each beneficiary in total number of votes. Off course, if the system 1 receives a self-report, the system 1 sets a conversion period and converts a beneficiary in this case as well.

### The Sixth Embodiment

Different beneficiaries may be associated with a category of insurance accident for each insurance contract.

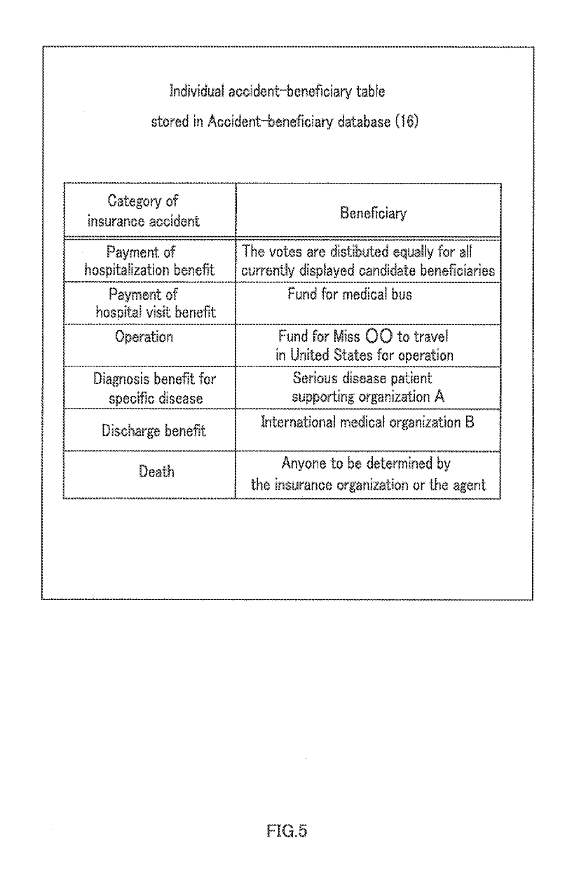

The system 1 receives an insurance accident information 13 indicating payment of insurance money or occurrence and detail of an insurance accident. The following processes are the same as the case that the insurance accident information 13 has been sent to the insured accident information receiving means 6 in the first, second, third or fourth embodiments. The demerit information processing means 7 retrieves a beneficiary corresponding to the category of insurance accident written in the received insurance accident information 13 from the individual accident-beneficiary database 16 (FIG. 5).

Then, the demerit information processing means 7 sends the retrieved beneficiary to the vote conversion means 15.

The vote conversion means 15 retrieves a voted beneficiary corresponding to the insurance accident information 13 from the aggregated votes data 9, converts the voted beneficiary to a beneficiary corresponding to the category of insurance accident and re-aggregates the converted beneficiary.

In case that an insurance contractor has a voting ticket before being voted or sent, the demerit information processing means 7 writes this fact in the insurance contractor database 4. After this writing, the demerit information processing means 7 fixes a beneficiary to be selected in future by the insurance contractor to a beneficiary corresponding to the category of insurance accident. The vote conversion means 15 may firstly detect existence of an insurance contractor before voting or sending a voting ticket, by referring at the time of voting to the insurance contractor database 4, and secondly fix a beneficiary selected by the insurance contractor (before voting or sending) to a beneficiary corresponding to the category of insurance accident and thirdly re-aggregate the converted beneficiary.

Such processes can set a beneficiary corresponding to the category of insurance accident for each insurance contract.

For example, in case of a motor insurance, some preferable beneficiaries may be set in accordance with age or residence area of the insurance contractor. The demerit information processing means 7 retrieves a beneficiary corresponding to the category of insurance accident written in the received insurance accident information 13 from the accident-beneficiary database 16 (FIG. 5). In this retrieving, the demerit information processing means 7 uses as a retrieving key one or more of zip code, address, name, sex, age and serial number of the insurance policy of the insurance contractor.

During the insurance period after an insurance accident, a normal state wherein a demerit is not imposed may come back. The processes described above can set a preferable beneficiary in accordance with features of the insurance contract or personal features of the insurance contractor.

### AVAILABILITY

The present invention is applicable to a mobile terminal device, such as a mobile telephone and a personal digital assistant, and a server or a terminal device of a system such as a large-scale computer.

### EXPLANATION OF REFERENCES

1 system for delivering and aggregating beneficiary voting ticket having function for conversion to demerit vote
2 storage means
3 vote delivery and aggregation means
4 insurance contractor database
5 conversion period database
6 insurance accident information receiving means
7 demerit information processing means
8 candidate beneficiary display means
9 aggregated votes data
10 computer system managing insurance contracts
11 terminal device of insurance contractor or insured person
12 network
13 insurance accident information
14 individual insurance contractor information
15 vote conversion means
16 accident-beneficiary database

1. A system for delivering and aggregating a vote with function to convert a voting ticket to a demerit voting ticket, the system
displaying on a home page of an insurance organization,
a guide that an insurance organization and an insurance contractor make a donation and the insurance organization includes an agent that sales an insurance of a third field including a medical insurance and a cancer insurance, and a damage insurance including a pet insurance, and
a list information comprising a candidate beneficiary for which the insurance contractor or an insured person can vote,
converting the voting ticket to the demerit voting ticket with a predetermined demerit function during a specific period within an insurance period,
comprising;
a storage means storing a insurance contractor database,
a conversion period database, an aggregated votes data and an accident-beneficiary database,
wherein the conversion period database associating a conversion period during which the voting ticket is converted to the demerit voting ticket with a category of the insurance accident or a category of a payment of insurance money for each of the insurance contract,
a vote delivery and aggregation means sending the voting ticket via network to a terminal device operated by the insurance contractor or the insured person for each of the specific period and aggregating the voting ticket sent back from the insurance contractor or the insured person to store a result of the aggregation in the storage means,
an insurance accident information receiving means receiving, from a computer system for managing insurance contracts, an insurance accident information indicating the category of the insurance accident or the category of the payment of insurance money for each of the insurance contract,
a demerit information processing means, responsive to receiving the insurance accident information by the insurance accident information receiving means, retrieving the conversion period database using as a key the category of the insurance accident or the category of the payment of insurance money for each of the insurance contract to obtain the conversion period corresponding to the received insurance accident information and
storing the obtained conversion period or the category of the insurance accident or a period for the payment of insurance money for each of the insurance contract in an individual insurance contractor information corresponding to the received insurance accident information,
a vote conversion means converting the sent back voting ticket from the insurance contractor or the insured person corresponding to the received insurance accident information to the demerit voting ticket during the conversion period or the period for the payment of insurance money and aggregating or re-aggregating a number of the converted voting ticket or the conversion period or the period for the payment of insurance money stored in the individual insurance contractor information.

2. The system of claim 1, wherein the vote delivery and aggregation means further
receiving the voting ticket via network including internet from the terminal device operated by the insurance contractor or the insured person,
writing a voting date of the received voting ticket and the beneficiary selected by the voting ticket in the received individual insurance contractor information stored in the storage means,
converting the beneficiary selected by the voting ticket to a predetermined beneficiary, in case that the voting date is within the conversion period already written in the individual insurance contractor information and
aggregating the converted beneficiary.

3. The system of claim 1, wherein the vote delivery and aggregation means, when sending newly the voting ticket, further
retrieving the conversion period from the individual insurance contractor information to identify the insurance contractor whose conversion period includes a date of sending the voting ticket and
converting the voting ticket to the demerit voting ticket to send the converted demerit voting ticket to the identified insurance contractor or determining not to send the voting ticket to the identified insurance contractor.

4. The system of claim 1, wherein the demerit information processing means, after receiving the insurance accident information by insurance accident information receiving means, further
obtaining the beneficiary for each of the insurance accident corresponding to the insurance accident information from the accident-beneficiary database using as a key the category of the insurance accident or the category of the payment of insurance money for each of the insurance contract and
storing the obtained beneficiary for each of the insurance accident in an individual insurance contractor information corresponding to the received insurance accident information or
the vote conversion means,
converting the beneficiary for the insurance contractor or the insured person corresponding to the received insurance accident information to the beneficiary for each of the insurance accident, and aggregating or re-aggregating the beneficiaries.

5. The system of claim 1, wherein the demerit information processing means further
determining whether the date when the obtained conversion period is to be newly written in the individual insurance contractor information is included within the old conversion period already written in the individual insurance contractor information,
in case that the date is included within the already written conversion period,
calculating and writing a new ending date of the conversion period by adding the obtained conversion period to the old conversion period with a new starting date being the following date of the ending date of the old conversion period or
updating the old conversion period by summing up the old conversion period and the obtained conversion period,
in case that the date is not included within the already written conversion period,
determining not to change the sent back voting ticket.

6. The system of claim 1, wherein the individual insurance contractor information being
one or more of a mail address, a zip code, an address, name, sex, an age, telephone number, an identification number or code of the insurance contractor determined by the insurance contractor or the agent and serial number of the insurance policy, or
the insurance accident information being one or more of an information related to the insurance contractor or the insured person, a name of the insurance company, a name of the insurance contractor, a name of the insurance accident, a date of occurrence of the insurance accident, a date of payment of the insurance money or a benefit, or a period of payment of the insurance money or the benefit.

7. The system of claim 1, wherein the process to convert to the demerit voting ticket being
fixing the beneficiary to a pre-displayed candidate beneficiary or
converting the beneficiary already selected by the voting ticket forcibly to the pre-displayed candidate beneficiary.

8. The system of claim 1, wherein the insurance accident information receiving means further
receiving the insurance accident information from the terminal device operated by the insurance contractor or the insured person via a network.
